(19) United States
(12) Patent Application Publication
(10) Pub. No.: US 2005/0103763 A1
(43) Pub. Date: May 19, 2005

(54) Method of and apparatus for machining groove with laser beam

(75) Inventor: Yasuo Momose, Utsunomiya-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 10/968,912

(22) Filed: Oct. 21, 2004

(30) Foreign Application Priority Data
Oct. 23, 2003 (JP) 2003-363297

(51) Int. Cl. B23K 26/38; B23K 26/16

(52) U.S. Cl. 219/121.69; 219/121.84

(57) ABSTRACT

A casing houses therein a laser oscillator for emitting a laser beam, and a tubular head is disposed coaxially with the laser oscillator and coupled to the casing. The laser beam emitted from the laser oscillator is converged by a condenser lens mounted on the head, and then reflected in a direction substantially perpendicular to the axis of the head by a reflecting mirror that is disposed in the head. The reflected laser beam is applied substantially perpendicular to the inner circumferential surface of a workpiece, forming grooves therein with the heat of the laser beam.

### BACKGROUND OF THE INVENTION

1. Field of the Invention

The present invention relates to a method of and an apparatus for machining a straight groove in an inner cylindrical surface of a workpiece made of a metal material, by applying a laser beam thereto.

2. Description of the Related Art

There have heretofore been known methods of and apparatus for applying a laser beam to a workpiece made of a metal material to cut or machine the workpiece with the heat generated by the applied laser beam.

According to such laser beam machining method, as shown in FIG. 6 of the accompanying drawings, a laser beam 1 emitted from a laser oscillator is guided to a condenser lens 3 of an application nozzle 2 which is disposed coaxially with the laser oscillator. The laser beam 1 is converged by the condenser lens 3 and applied from the application nozzle 2 linearly to the surface of a workpiece 4 that is made of a metal material. The application nozzle 2 which applies the laser beam 1 is inclined a certain angle to the surface of the workpiece 4, so that the laser beam 1 is applied obliquely at the same angle to the workpiece 4. When the laser beam 1 is applied to the workpiece 4, the workpiece 4 is heated by the energy of the applied laser beam 1, and the surface of the workpiece 4 is cut to machine a groove therein.

When the surface of the workpiece 4 is machined by the laser beam 1, scales are produced on the surface of the workpiece 4 because of the heating of the workpiece 4. An ejector nozzle 5 is disposed in the vicinity of the region of the surface of the workpiece 4 where the laser beam 1 is applied, and a supply pipe 7 is connected to a side wall of the application nozzle 2. An assist gas 6 is ejected through the ejector nozzle 5 and the supply pipe 7 toward the surface of the workpiece 4, blowing the scales off the workpiece 4 (for details, see Japanese Laid-Open Patent Publication No. 58-125391, for example).

Generally, for machining a workpiece made of a metal material with a laser beam, the laser beam is applied substantially perpendicularly to the surface to be machined of the workpiece for highly accurate and stable machining operation.

According to the machining process disclosed in Japanese Laid-Open Patent Publication No. 58-125391, the laser oscillator for emitting the laser beam 1 and the application nozzle 2 are disposed coaxially with each other, and the laser beam 1 is applied from the application nozzle 2 linearly to the surface of the workpiece 4. Therefore, a sufficient space is required above the surface to be machined of the workpiece 4 for placing the laser oscillator and the application nozzle 2 therein in order to apply the laser beam 1 to the workpiece 4.

If a groove is to be formed by a laser beam in an inner wall surface of a cylindrical workpiece within the hole thereof, e.g., the larger end hole of a connecting rod for use in a vehicular engine, then depending on the size of the hole, a laser oscillator and an application nozzle may not be inserted in the hole to be oriented substantially perpendicularly to the inner wall surface in the hole.

In such a case, the laser oscillator and the application nozzle are inclined a certain angle to the inner wall surface of the workpiece and positioned outside of the hole. Though no space is available to put the laser oscillator and the application nozzle within the hole of the workpiece, a groove may be formed in the inner wall surface of the workpiece by the laser beam applied by the application nozzle.

However, since the laser beam is applied obliquely to the inner wall surface of the workpiece, it is difficult to control the machining process for keeping the depth of the groove substantially constant throughout the groove.

When the above machining process is employed to form a groove in the inner wall surface of the larger end hole of a connecting rod for use in a vehicular engine, and the larger end of the connecting rod is split from the groove into a shank and a cap, it is difficult to keep the depth of the groove substantially constant throughout the groove. Accordingly, it is necessary to increase the impact force that is to be applied to split the larger end of the connecting rod. When a large impact force is set to split the connecting rod, however, the facility cost tends to increase and the yield of a connecting rod reduces as defective connecting rods are liable to be produced when split under the large impact force.

### SUMMARY OF THE INVENTION

It is a general object of the present invention to provide a method of and an apparatus for machining a groove in an inner cylindrical surface of a workpiece highly accurately by applying a laser beam substantially perpendicularly to the inner cylindrical surface.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view of a machining apparatus for carrying out a method of machining a groove with a laser beam according to a first embodiment of the present invention;

FIG. 2 is a vertical cross-sectional view of the machining apparatus shown in FIG. 1, taken along the axis thereof;

FIG. 3 is a fragmentary plan view, partly in cross section, of a portion of the machining apparatus shown in FIG. 2, near a head and a reflecting mirror;

FIG. 4 is a vertical cross-sectional view of a machining apparatus for carrying out a method of machining a groove with a laser beam according to a second embodiment of the present invention, the view being taken along the axis of the machining apparatus;

FIG. 5 is a fragmentary plan view, partly in cross section, of a portion of the machining apparatus shown in FIG. 4, near a head and a reflecting mirror; and

FIG. 6 is a vertical cross-sectional view of a machining apparatus for carrying out a conventional laser beam machining method.

### DESCRIPTION OF THE PREFERRED EMBODIMENTS

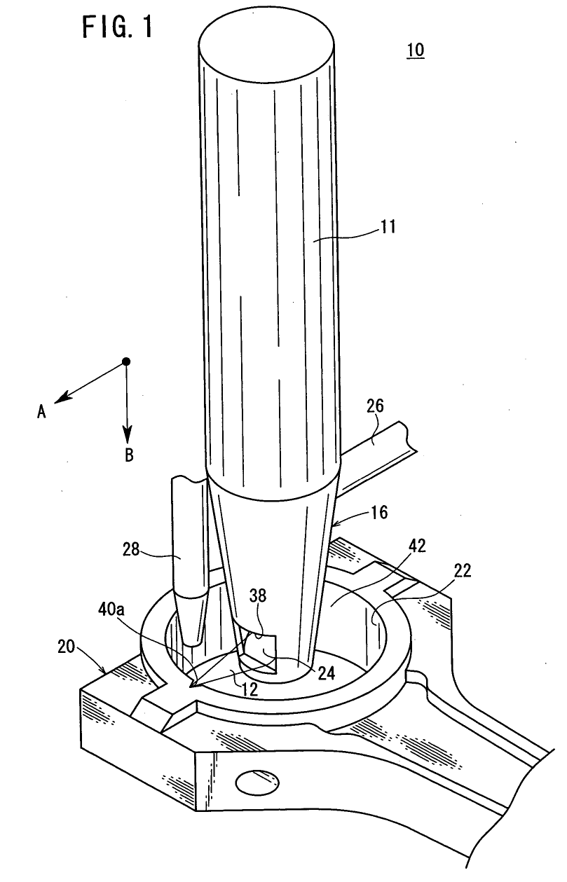

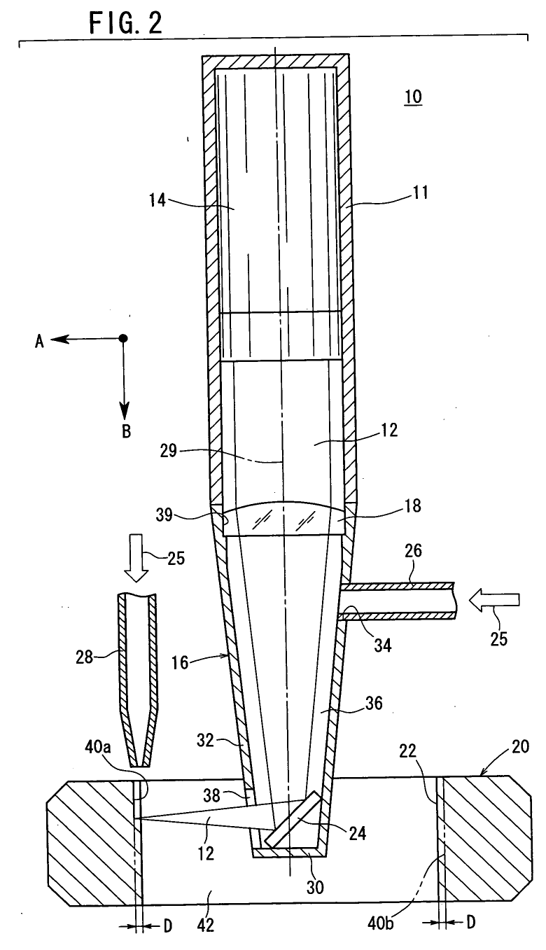

FIGS. 1 and 2 show an apparatus 10 for machining a groove with a laser beam (hereinafter referred to as “machining apparatus 10”) according to a first embodiment of the present invention.

The machining apparatus 10 comprises a casing (body) 11 mounted on the end of an arm of an industrial articulated robot (e.g., a numerically-controlled apparatus), a laser oscillator 14 disposed in the casing 11 for emitting a laser beam 12, and a tubular head 16 disposed coaxially with the laser oscillator 14 and coupled to the lower end of the casing 11.

The machining apparatus 10 also has a condenser lens 18 held on the upper end of the head 16 for converging the laser beam 12 emitted from the laser oscillator 14 downwardly. A reflecting mirror 24 is fixedly mounted in the lower end of the head 16 and slanted at a certain angle to the vertical axis 29 of the head 16. The reflecting mirror 24 serves to reflect the laser beam 12 emitted from the laser oscillator 14 along the axis 29 into a direction which is substantially perpendicular to an inner circumferential surface (inner cylindrical surface) 22 of a workpiece 20, such as a connecting rod for use in a vehicular engine. An assist gas 25 from a gas supply source (not shown) is supplied through a first gas tube 26 and a second gas tube 28.

The laser oscillator 14 is continuously oscillated or pulse-oscillated to output the laser beam 12 into the head 16. Specifically, the laser beam 12 is emitted from either a CO₂ laser which can be continuously oscillated or pulse-oscillated, or a YAG laser which can be pulse-oscillated. The laser beam 12 may be oscillated with high-frequency modulation pulses having a frequency of 100 Hz or higher.

The head 16 comprises a substantially conical tubular member which is progressively reduced in diameter downwardly, and is spaced a certain distance downwardly from the laser oscillator 14 in coaxial relation thereto. The condenser lens 18 is mounted in the upper open end of the head 16 which is open toward the laser oscillator 14. The head 16 has a bottom wall 30 on its lower end which lies substantially perpendicular to the axis 29 of the head 16 and closes the lower end of the head 16.

The head 16 also has a side wall 32 having a hole 34 defined in an upper portion thereof. The first gas tube 26 which is supplied with the assist gas 25 has an end fitted in the hole 34 such that the first gas tube 26 is connected substantially perpendicularly to the side wall 32. The first gas tube 26 communicates with the interior of the head 16 for introducing the assist gas 25 supplied from the gas supply source into a space 36 in the head 16.

The side wall 32 also has an emission hole 38 defined in a lower portion thereof in horizontal alignment with the reflecting surface of the reflecting mirror 24. The laser beam 12 traveling from the condenser lens 18 toward the reflecting mirror 24 in the head 16 is reflected by the reflecting mirror 24 at an angle of 90° and emitted out of the head 16 through the emission hole 38. The emission hole 38 extends upwardly from the upper surface of the bottom wall 30 and is open substantially horizontally. The emission hole 38 has an opening greater than the diameter of the laser beam 12 as it passes through the emission hole 38.

The head 16 is connected to the arm of the robot integrally with the laser oscillator 14. When the robot is operated, the machining apparatus 10 mounted on the robot is moved to any desired position in a three-dimensional space having three coordinate axes, X-, Y-, and Z-axes, and oriented in any desired direction.

The condenser lens 18, which is of a substantially circular shape, comprises a planoconvex lens having a convex upper surface and a substantially flat lower surface. The condenser lens 18 is mounted in a mount groove 39 defined in the upper portion of the head 16. When the laser beam 12 is applied to the convex upper surface of the condenser lens 18, the laser beam 12 is converged to a point below the condenser lens 18. The condenser lens 18 may alternatively comprise a double-convex lens having convex upper and lower surfaces.

The reflecting mirror 24 is in the form of a plate disposed in the head 16 on the bottom wall 30 and surrounded by the lower portion of the side wall 32. The reflecting mirror 24 is slanted at about 45° to the vertical axis 29 of the head 16. The reflecting mirror 24 is positioned such that the central axis of the laser beam 12 traveling downwardly in the head 16 is applied to a substantially central area of the upper surface of the reflecting mirror 24.

The reflecting mirror 24 may be made of tungsten or molybdenum, or may have only its upper surface covered with a layer of tungsten or molybdenum.

When the laser beam 12 emitted from the laser oscillator 14 travels in the head 16 to the reflecting mirror 24, the laser beam 12 is reflected at 90° by the reflecting mirror 24, which is slanted at about 45° to the vertical axis 29 of the head 16 so as to face the emission hole 38. The reflected laser beam 12 is applied through the emission hole 38 to the workpiece 20 that is placed outside of the head 16.

The first gas tube 26, which is connected substantially perpendicularly to the upper portion of the side wall 32 through the hole 34, supplies an assist gas from the non-illustrated gas supply source coupled to an end of the first gas tube 26 into the head 16. The assist gas 25 introduced from the first gas tube 26 into the head 16 is then supplied through the emission hole 38 to the inner circumferential surface 22 of the workpiece 20.

The second gas tube 28 is spaced a predetermined distance from and extends parallel to the head 16, and has an end connected to the non-illustrated gas supply source and another end, serving as a discharge port, tapered toward the workpiece 20. The second gas tube 28 is disposed in a position facing the upper surface of the workpiece 20. Specifically, the discharge port of the second gas tube 28 is spaced a predetermined distance upwardly from the upper edge of the inner circumferential surface 22 of the workpiece 20, in which grooves 40a, 40b are to be machined by the laser beam 12.

The assist gas 25 supplied to the first gas tube 26 and the second gas tube 28 comprises air, nitrogen, argon, or oxygen, which is selected depending on the material of the workpiece 20 where the grooves 40a, 40b are to be formed.

The machining apparatus 10 according to the first embodiment is basically constructed as described above. Operation and advantages of the machining apparatus 10 will be described below. A connecting rod serving as the workpiece 20 is placed on a placement table (not shown), and the machining apparatus 10 operates to form a pair of cracking grooves 40a, 40b in the inner circumferential surface 22 of a larger end hole 42 of the connecting rod for the purpose of assisting in splitting the connecting rod into a shank and a cap.

First, the machining apparatus 10 is placed in an initial position above the workpiece 20 that is fixed on the placement table. Then, the machining apparatus 10 is moved by the non-illustrated robot from the initial position substantially in a horizontal direction (indicated by the arrow A in FIG. 1) to a position where the center of the larger end hole 42 of the connecting rod is aligned with the axis 29 of the head 16 of the machining apparatus 10.

Then, the machining apparatus 10 is moved by the robot downwardly in the direction indicated by the arrow B along the axis 29. When the machining apparatus 10 is moved downwardly, the laser oscillator 14 housed in the casing 11, the head 16, and the reflecting mirror 24 disposed in the head 16 are displaced downwardly in unison with each other in the direction indicated by the arrow B.

An electric power supply (not shown) supplies an electric current to the laser oscillator 14, which is continuously oscillated or pulse-oscillated to emit the laser beam 12 into the head 16. The laser beam 12 travels through the space 36 in the head 16 that is coaxial with the laser oscillator 14, and is applied to the upper surface of the reflecting mirror 24. Since the reflecting mirror 24 is fixed and slanted at about 45° to the vertical axis 29 of the head 16, the laser beam 12 is reflected by the reflecting mirror 24 so as to travel at 90° with respect to the vertical axis 29, i.e., substantially horizontally, and is emitted from the emission hole 38 that is defined in the side wall 32 of the head 16.

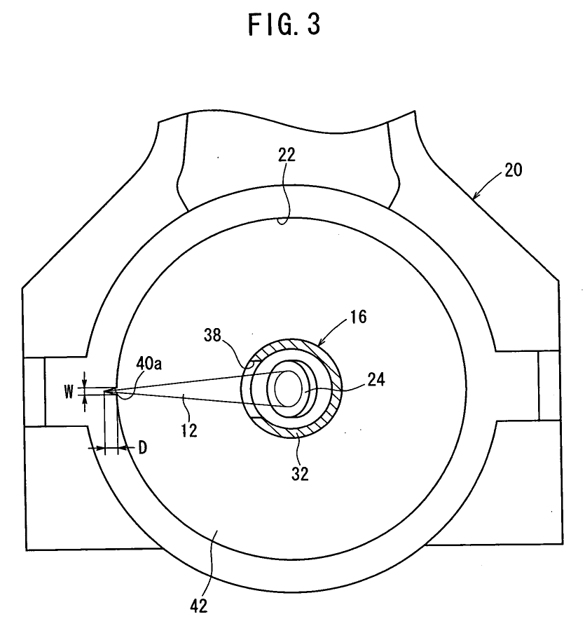

While the laser beam 12 is being emitted from the emission hole 38 substantially perpendicularly to the vertical axis 29 of the head 16, the machining apparatus 10 is gradually moved downwardly in the direction indicated by the arrow B along the vertical axis 29. The head 16 is displaced into the larger end hole 42, applying the laser beam 12 emitted from the emission hole 38 substantially perpendicularly to the inner circumferential surface 22 of the larger end hole 42. As shown in FIG. 3, a groove 40a of a substantially V-shaped cross section is now formed in the inner circumferential surface 22 with the heat of the applied laser beam 12, the groove 40a having a certain depth in the radial direction of the inner circumferential surface 22.

As the machining apparatus 10 is further moved downwardly in the direction indicated by the arrow B along the vertical axis 29, the groove 40a having a substantially constant width is formed straightly in and along the inner circumferential surface 22 of the larger end hole 42.

At this time, a molten dross heated by the laser beam 12 is produced on the inner circumferential surface 22 in the vicinity of the groove 40a. Therefore, the assist gas 25 supplied from the non-illustrated gas supply source through the first gas tube 26 is ejected from the emission hole 38 to the inner circumferential surface 22 of the larger end hole 42, and the assist gas 25 is also ejected from the discharge port of the second gas tube 28 to the inner circumferential surface 22 of the larger end hole 42, blowing away the dross from the region of the inner circumferential surface 22 near the groove 40a.

Another groove 40b is to be formed in the inner circumferential surface 22 in diametrically opposite relation to the groove 40a. The groove 40b is machined by the machining apparatus 10 at a position facing the groove 40a that has been formed as described above.

Specifically, the non-illustrated robot turns the machining apparatus 10 by 180° about the axis 29 from the angular position in which the machining apparatus 10 has been oriented to form the groove 40a. After the axis 29 is aligned with the center of the larger end hole 42, the machining apparatus 10 is displaced downwardly in the direction indicated by the arrow B into the larger end hole 42. The laser beam 12 is emitted again, forming the groove 40b straightly in and along the inner circumferential surface 22 of the workpiece 20 in diametrically opposite relation to the groove 40a. As a result, the grooves 40a, 40b, which are of a substantially constant depth, are now formed in the inner circumferential surface 22.

At this time, a dross produced on the inner circumferential surface 22 near the groove 40b is also blown away by the assist gas 25 which is ejected from the first gas tube 26 through the emission hole 38 to the inner circumferential surface 22 and the assist gas 25 which is ejected from the second gas tube 28 to the inner circumferential surface 22.

The depth D (see FIGS. 2 and 3) of the grooves 40a, 40b formed in the inner circumferential surface 22 is set to a value in the range from 0.2 to 0.7 mm. The width W (see FIG. 3) of the grooves 40a, 40b is set to a value in the range from 0.1 to 0.4 mm. Undesirably, the depth D of the grooves 40a, 40b may change along the axial direction. If the depth D changes, the difference between the depth D′ of the portion which is deepest and the depth D″ of the portion which is shallowest should be 50% or less of the depth D′. In other words, the rate of change between the depth D′ and the depth D″ is 50% or less.

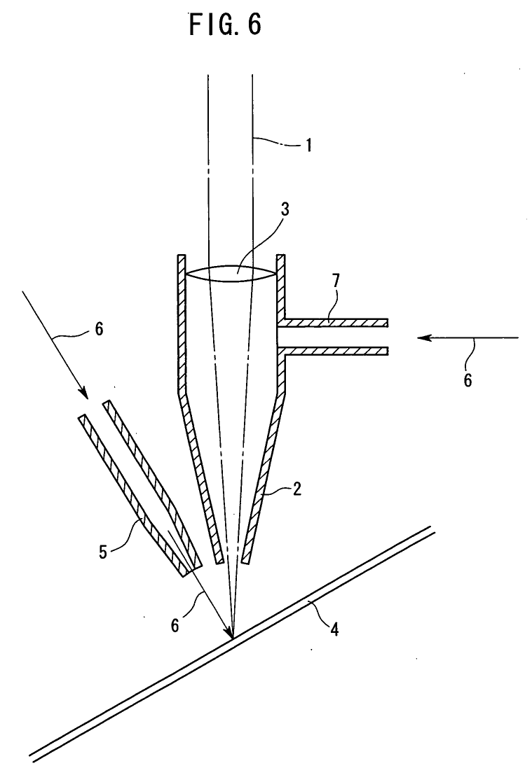

Accordingly, the grooves 40a, 40b are formed to a substantially constant depth in the inner circumferential surface 22 of the larger end hole 42 of the workpiece 20 with a high degree of accuracy. Even if the depth D of the grooves 40a, 40b is made smaller than grooves that are made by the conventional laser beam 1 (see FIG. 6) which is inclined a certain angle to the inner wall surface of the workpiece, the connecting rod can reliably and simply be split from the grooves 40a, 40b formed in the inner circumferential surface 22. Therefore, the product yield can be increased when the connecting rod as the workpiece 20 is machined.

According to the first embodiment, as described above, the reflecting mirror 24 is inclined about 45° and fixed on the head 16 that is disposed coaxially with the laser oscillator 14, and the laser beam 12 output from the laser oscillator 14 is reflected 90° so as to be emitted substantially horizontally from the head 16. Consequently, even if the hole in the workpiece 20 where the grooves 40a, 40b are to be formed has a small diameter, the casing 11 housing the laser oscillator 14 therein and the head 16 do not need to be inclined with respect to the workpiece 20. The head 16 can be inserted into the hole in the workpiece 20 and apply the laser beam 12 substantially perpendicularly to the inner circumferential surface 22 of the workpiece 20 to highly accurately form the grooves 40a, 40b having a substantially constant depth therein.

According to the conventional laser beam machining method, the laser beam 1 is inclined a certain angle and directly applied to the inner circumferential surface of the workpiece. According to the first embodiment, however, the laser beam 12 is applied substantially perpendicularly to the inner circumferential surface 22 of the workpiece 20 by the reflecting mirror 24. As the laser beam 12 is applied substantially perpendicularly to the inner circumferential surface 22, the depth D and shape of the grooves 40a, 40b formed by the laser beam 12 can be controlled with high accuracy.

Since the grooves 40a, 40b are shaped substantially identically, the connecting rod as the workpiece 20 can be split with smaller forces from the grooves 40a, 40b. Therefore, the forces that need to be applied to the larger end hole 42 may be reduced. Furthermore, inasmuch as the depth D of the grooves 40a, 40b which is required to split the connecting rod are substantially constant, the depth D may be reduced.

The laser beam 12 makes it possible to form grooves 40a, 40b into an acute-angled shape of a substantially V-shaped cross section by the laser beam 12, unlike other machining processes such as broaching to form grooves in the inner circumferential surface 22. Since the acute-angled grooves 40a, 40b allow the connecting rod to crack easily therefrom, the yield of products is increased.

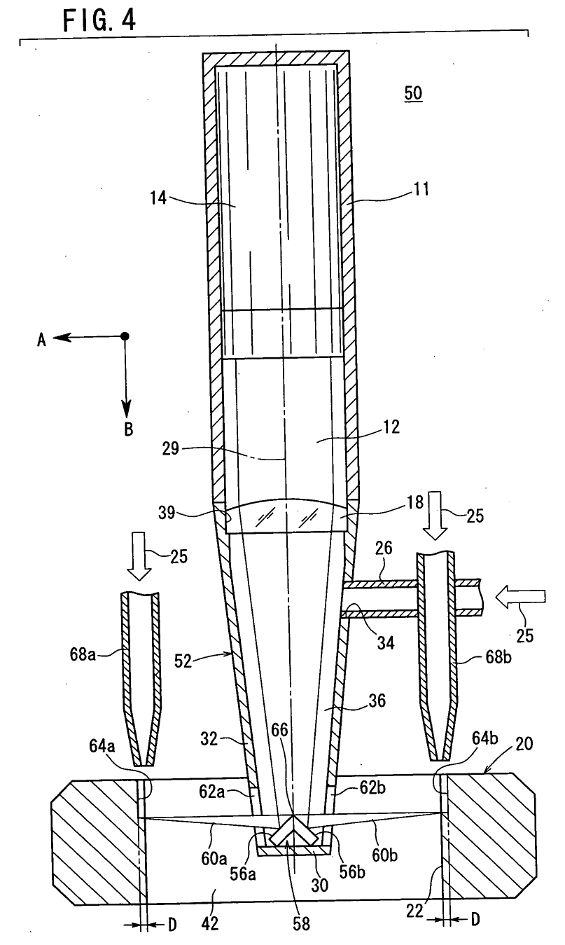

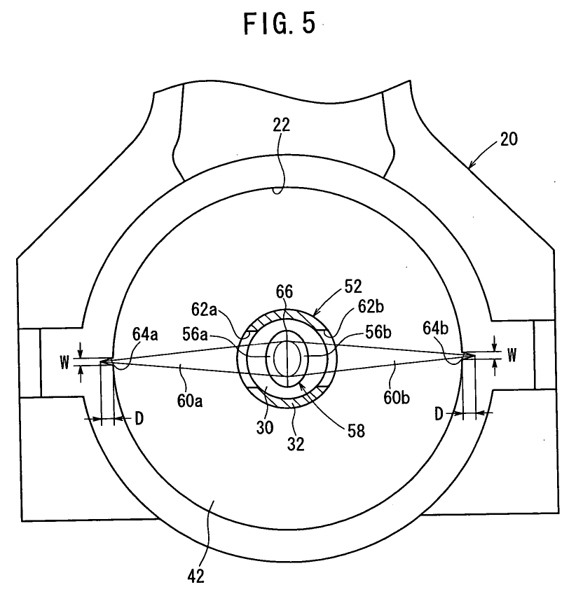

An apparatus 50 for machining a groove with a laser beam (hereinafter referred to as “machining apparatus 50”) will be described below with reference to FIGS. 4 and 5. Those parts of the machining apparatus 50 which are identical to those of the machining apparatus 10 according to the first embodiment are denoted by identical reference characters, and will not be described in detail below.

The machining apparatus 50 according to the second embodiment of the present invention has a reflecting mirror 58 mounted on the bottom wall 30 of a head 52 in the form of a substantially conical tubular member. The reflecting mirror 58 has a pair of mirror surfaces 56a, 56b slanted at a certain angle symmetrically with respect to the axis 29 of the head 52. The mirror surfaces 56a, 56b face away from each other and confront respective emission holes 62a, 62b which are formed in the lower portion of the side wall 32 of the head 52 in diametrically opposite relation to each other. The reflecting mirror 58 divides the laser beam 12 emitted from the laser oscillator 14 into two beams 60a, 60b, which are applied through the emission holes 62a, 62b to the inner circumferential surface 22 of the workpiece 20, forming respective grooves 64a, 64b substantially simultaneously in the inner circumferential surface 22.

As shown in FIG. 4, the reflecting mirror 58, which is of a substantially triangular cross-sectional shape, is fixed on the bottom wall 30 of the head 52. The reflecting mirror 58 has its upper ridge 66 positioned on the axis 29 of the head 52, and the mirror surfaces 56a, 56b extend obliquely downwardly from the upper ridge 66 at an angle of 45° with respect to the axis 29. The mirror surfaces 56a, 56b are thus slanted 45° to the axis 29.

The emission holes 62a, 62b formed in the lower portion of the side wall 32 of the head 52 in diametrically opposite relation to each other allow the respective laser beams 60a, 60b, which have been reflected by the reflecting mirror 58 at 90° with respect to the axis 29, to be emitted out of the head 52. The emission holes 62a, 62b extend upwardly from the upper surface of the bottom wall 30 and are open substantially horizontally. The emission holes 62a, 62b are positioned on a straight line passing through the center of the head 52 (see FIG. 5) facing the respective mirror surfaces 56a, 56b of the reflecting mirror 58.

Second gas tubes 68a, 68b for ejecting the assist gas 25 to the inner circumferential surface 22 of the workpiece 20 are disposed one on each side of the head 52. The second gas tubes 68a, 68b are spaced a predetermined distance from and extend parallel to the head 52. Specifically, the second gas tubes 68a, 68b are positioned above the inner circumferential surface 22 of the workpiece 20, in which grooves 64a, 64b are to be machined by the laser beams 60a, 60b.

With the connecting rod as the workpiece 20 being fixed on the non-illustrated placement table, the machining apparatus 50 above the connecting rod is moved by the non-illustrated robot in a horizontal direction (indicated by the arrow A in FIG. 4) to a position where the center of the larger end hole 42 of the connecting rod is aligned with the axis 29 of the head 52 of the machining apparatus 50. Then, the machining apparatus 50 is moved by the robot downwardly in the direction indicated by the arrow B along the axis 29.

The laser oscillator 14 emits the laser beam 12 which passes through the space 36 in the head 52 along the vertical axis 29. The laser beam 12 is applied to the mirror surfaces 56a, 56b of the reflecting mirror 58. Since the mirror surfaces 56a, 56b are slanted symmetrically 45° from the upper ridge 66, the laser beam 12 is divided into and reflected as the laser beams 60a, 60b in horizontal directions at 90° with respect to the axis 29. The reflected laser beams 60a, 60b are emitted out of the emission holes 62a, 62b, respectively, toward the inner circumferential surface 22 of the workpiece 20.

Then, the machining apparatus 50 is moved downwardly in the direction indicated by the arrow B along the axis 29. The head 52 of the machining apparatus 50 is displaced downwardly into the larger end hole 42, and the laser beams 60a, 60b emitted out of the emission holes 62a, 62b are applied substantially perpendicularly to the inner circumferential surface 22, forming the grooves 64a, 64b with a predetermined width straightly in and along the inner circumferential surface 22 with the heat of the laser beams 60a, 60b. The grooves 64a, 64b are of a substantially V-shaped cross-sectional shape, and are substantially identical in shape and depth to each other.

At this time, a molten dross heated by the laser beams 60a, 60b is produced on the inner circumferential surface 22 in the vicinity of the grooves 64a, 64b. The assist gas 25 supplied from the non-illustrated gas supply source through the first gas tube 26 is ejected from the emission holes 62a, 62b to the inner circumferential surface 22, and simultaneously, the assist gas 25 is also ejected from the second gas tubes 68a, 68b to the inner circumferential surface 22, blowing away the dross from the regions of the inner circumferential surface 22 near the grooves 64a, 64b.

Therefore, the grooves 64a, 64b which are substantially identical in shape can be formed simultaneously in the inner circumferential surface 22 of the larger end hole in the connecting rod as the workpiece 20. Therefore, the process of machining the grooves 64a, 64b is simplified and performed in a relatively short period of time. As a consequence, the cost of the connecting rod is reduced.

Although certain preferred embodiments of the present invention have been shown and described in detail, it should be understood that various changes and modifications may be made therein without departing from the scope of the appended claims.

1. A method of machining a groove in a workpiece by applying a laser beam emitted from a laser oscillator to the workpiece, comprising the steps of:
converging the laser beam emitted from the laser oscillator coaxially with the axis of an inner cylindrical surface of the workpiece, with a condenser lens;
thereafter, reflecting the laser beam substantially at a right angle to said axis with a mirror which is slanted a predetermined angle to said axis;
applying the reflected laser beam substantially perpendicularly to said inner cylindrical surface;
ejecting a gas to said inner cylindrical surface which is irradiated with said laser beam; and
displacing the laser oscillator and the mirror in unison along said axis while said laser beam is being applied to said inner cylindrical surface, thereby forming a pair of grooves straightly in and along said axis of said inner cylindrical surface.

2. A method according to claim 1, wherein after a first groove of said grooves is formed in said inner cylindrical surface of said workpiece, said mirror is turned 180° about said axis, and the said laser beam is applied to said inner cylindrical surface, thereby forming a second groove of said grooves straightly in and along said axis of said inner cylindrical surface facing said first groove.

3. A method according to claim 1, wherein said laser beam is divided into two laser beams by said mirror to form said pair of grooves substantially simultaneously in said inner cylindrical surface.

4. A method according to claim 1, wherein said gas is supplied to said inner cylindrical surface through a body housing said laser oscillator therein, and is also supplied to said inner cylindrical surface through a gas tube extending substantially parallel to an axis of said body.

5. A method according to claim 4, wherein said laser beam which is reflected substantially at the right angle to said axis with said mirror is applied to said inner cylindrical surface through an emission hole which is defined in said body facing said inner cylindrical surface.

6. A method according to claim 5, wherein said gas which is supplied through said body is ejected from said emission hole to said inner cylindrical surface.

7. A method according to claim 1, wherein said mirror has a mirror surface for reflecting said laser beam, said mirror surface being slanted 45° with respect to said axis toward said inner cylindrical surface.

8. A method according to claim 1, wherein said grooves have an acute-angled shape of a substantially V-shaped cross section.

9. A method according to claim 8, wherein said grooves have a width ranging from 0.1 to 0.4 mm in the circumferential direction of said inner cylindrical surface and a depth ranging from 0.2 to 0.7 mm in the radial direction of said inner cylindrical surface.

10. An apparatus for machining a groove in a workpiece by applying a laser beam emitted from a laser oscillator to the workpiece, comprising:
a condenser lens for converging the laser beam emitted from the laser oscillator coaxially with the axis of an inner cylindrical surface of the workpiece;
a mirror having a mirror surface which is slanted a predetermined angle to said axis, for reflecting the laser beam which is converged by said condenser lens; and
a gas tube for ejecting a gas to said inner cylindrical surface which is irradiated with said laser beam;
wherein said laser beam is reflected at a substantially right angle to said axis by said mirror, and applied to said inner cylindrical surface, thereby forming a pair of grooves in said inner cylindrical surface along said axis.

11. An apparatus according to claim 10, wherein said mirror has a mirror surface for reflecting said laser beam, said mirror surface being slanted 45° with respect to said axis toward said inner cylindrical surface.

12. An apparatus according to claim 10, wherein said mirror has a pair of mirror surfaces for reflecting said laser beam, each of said mirror surfaces being slanted 45° with respect to said axis toward said inner cylindrical surface.

13. An apparatus according to claim 10, wherein said gas tube is connected to a body housing said laser oscillator therein, and extends substantially parallel to an axis of said body.

14. An apparatus according to claim 13, wherein said body has an emission hole defined therein facing said inner cylindrical surface, for emitting therethrough the laser beam reflected at the substantially right angle by said mirror.

15. An apparatus according to claim 14, wherein said gas which is supplied from said gas tube through said body is ejected from said emission hole to said inner cylindrical surface of said workpiece.

16. An apparatus according to claim 10, wherein said grooves have an acute-angled shape of a substantially V-shaped cross section.

17. An apparatus according to claim 16, wherein said grooves have a width ranging from 0.1 to 0.4 mm in the circumferential direction of said inner cylindrical surface and a depth ranging from 0.2 to 0.7 mm in the radial direction of said inner cylindrical surface.

18. An apparatus according to claim 10, wherein said mirror is made of tungsten or molybdenum, or has a surface covered with a layer of tungsten or molybdenum.

19. An apparatus according to claim 10, wherein said gas comprises any one of air, nitrogen, argon, and oxygen.

20. An apparatus according to claim 10, wherein said laser beam comprises a CO₂ laser beam or a YAG laser beam, and is continuously modulated or pulse-modulated at a frequency of at least 100 Hz.
